(19) United States
(12) Patent Application Publication
(10) Pub. No.: US 2025/0076231 A1
(43) Pub. Date: Mar. 6, 2025

(54) MONITORING DEVICE

(71) Applicant: Nippon Telegraph and Telephone Corporation, Tokyo (JP)

(72) Inventors: Mamoru Mizunuma, Tokyo (JP); Shota Oki, Tokyo (JP); Shingo Mineta, Tokyo (JP); Masayuki Tsuda, Tokyo (JP)

(21) Appl. No.: 18/724,010

(22) PCT Filed: Mar. 15, 2022
(86) PCT No.: PCT/JP2022/011563

§ 371 Date: Jun. 25, 2024

(51) Int. Cl. G01N 25/72

(52) U.S. Cl. CPC G01N 25/72

(57) ABSTRACT

Provided are a light source that radiates (projects) infrared rays to a surface of a coating film which is an observation target, an infrared camera that captures a thermal image (infrared image) of a place irradiated with the infrared rays, and a display unit that displays the thermal image captured by the infrared camera. The thermal image captured by the infrared camera and displayed on the display unit is an image virtualized by superimposing a state (temperature distribution) of an infrared ray emitted from an object (for example, a coating film of a building) on which the infrared ray is projected in the shape of the object.

### CROSS-REFERENCE TO RELATED APPLICATIONS

This application is a national phase entry of PCT Application No. PCT/JP2022/011563, filed on Mar. 15, 2022, which application is hereby incorporated herein by reference.

### TECHNICAL FIELD

The present invention relates to an observation device that observes a state of a coating film applied to a building structure made of steel.

### BACKGROUND

Various building structures made of steel are used for long periods of time after the building structures are laid. Therefore, it is important to ensure anticorrosion properties, and states in which various resin paints are applied and overlapped to protect steel surfaces are general. However, there is a problem that bonding between base treatment materials and coating films are weakened due to base treatment methods during coating, coating methods, and the like, and the coating films peel. Although the deterioration is alleviated by improving coating techniques, it is difficult to avoid the occurrence of swelling, peeling, or the like in the coating films due to corrosion or the like under the coating films in which the bonding is weakened. When the coating films deteriorate and are consumed, and the deterioration further progresses and corrosion reaches the steel base material, swelling and peeling of the coating films occur. In these portions, it is necessary to perform rust removal (base material adjustment) and then newly perform repair such as painting. Countermeasures have been taken to find and detect initial deterioration of the coating films early.

Incidentally, as a method of inspecting such peeling of a coating film, infrared thermography may be used. In the field of failure diagnosis for electronic circuit components, a lock-in thermography technique of observing a heat generating portion (failure portion) due to short-circuiting, leakage, or the like occurring inside an electronic component, a module, a semiconductor device, or the like non-destructively from the outside of a resin mold has been utilized. Lock-in thermography is a technique of observing a heat generating portion with high sensitivity by synchronizing signal amplification between a current source that performs heating and an infrared sensor (camera) that performs reception and observation (Non Patent Literature 1).

Since the lock-in thermography technique can be used to observe a slight heat generating place with high sensitivity, using the lock-in thermography technique to find peeling of a coating film, concrete cracking, an internal defect, or the like of a large structure has been studied. The effectiveness of a passive method using solar radiation or a change in temperature as a heat source has also been confirmed (Non Patent Literature 2).

### CITATION LIST

### Non Patent Literature

Non Patent Literature 1: Ichiro Yoshi, “Applications of IR Lock-in Thermography to Failure Analysis for Power Device and Assembly”, Journal of The Japan Institute of Electronics Packaging, Vol. 17, No. 6, pages 479 to 483, 2014.
Non Patent Literature 2: Taisuke Sato, “Passhiburokkuin sekigaisen samogurafi-ho ni yoru hakuri kenshutsu genkai no kojo (in Japanese) (Improvement of Peeling Detection Limit by Passive Lock-in Infrared Thermography Method)”, the Japan Society of Civil Engineers, 63 Annual Academic Meeting, 5-163, pages 325 to 326, 2008.

### SUMMARY

### Technical Problem

However, in the above-described techniques, for example, in the case of a structure located under the ground, sunlight cannot be obtained, and a change in temperature is small. Therefore, it is not easy to confirm an initial symptom of corrosion deterioration of a base (a steel surface or the like) such as swelling and peeling of a coating film. Even in a structure located on the ground, the above-described techniques cannot be applied when there is no sunlight. In this way, in the above-described techniques, there is a problem that it is not easy to find a problem of coating such as deterioration or exhaustion of a coating film when sunlight cannot be obtained.

Embodiments of the present invention have been devised to solve the foregoing problems, and an object of embodiments of the present invention is to find a coating problem such as deterioration or exhaustion of a coating film even when sunlight cannot be obtained.

### Solution to Problem

According to an aspect of embodiments of the present invention, an observation device includes: a light source configured to radiate infrared rays to a surface of a target coating film; an infrared camera configured to capture a thermal image of a place irradiated with the infrared rays; and a display unit configured to display the thermal image captured by the infrared camera.

### Advantageous Effects of Embodiments of Invention

As described above, according to embodiments of the present invention, a thermal image of a place irradiated with infrared rays from a light source is captured by an infrared camera. Therefore, even when sunlight cannot be obtained, a problem of coating such as deterioration or exhaustion of a coating film can be found.

### BRIEF DESCRIPTION OF THE DRAWINGS

FIG. 1 is a diagram illustrating a configuration of an observation device according to an embodiment of the present invention.

FIG. 2A is a cross-sectional view illustrating a state in which a coating film 131 is swollen from a base steel plate 132 due to corrosion or the like.

FIG. 2B is a cross-sectional view illustrating a state in which the coating film 131 peels off the base steel plate 132 due to corrosion or the like.

### DETAILED DESCRIPTION OF ILLUSTRATIVE EMBODIMENTS

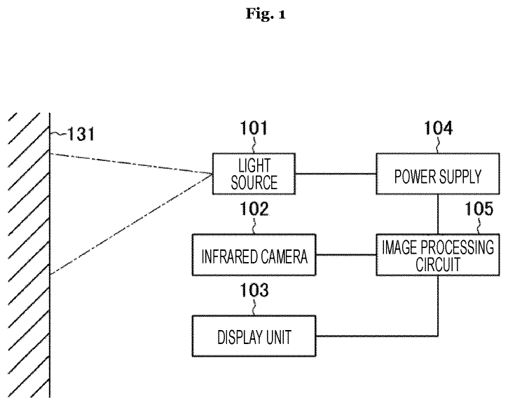

Hereinafter, an observation device according to an embodiment of the present invention will be described with reference to FIG. 1. The observation device includes a light source 101 that radiates (projects) infrared rays to a surface of a coating film 131 which is an observation target, an infrared camera 102 that captures a thermal image (infrared image) of a place irradiated with the infrared rays, and a display unit 103 that displays the thermal image captured by the infrared camera 102. A voltage of a set frequency is supplied from the power supply 104 to the light source 101.

The light source 101 is an infrared projector. For example, an infrared projector in which an infrared ray lamp and an infrared ray lens that converges progress of infrared rays are combined can be used. The light source 101 can include an infrared laser and a diffractive optical element that further widens an irradiation distribution of infrared laser light emitted from the infrared laser. For example, the diffractive optical element linearly widens spot-shaped infrared laser light emitted from the infrared laser at a predetermined length while the infrared laser beam is transmitted or reflected. In this case, for example, the infrared rays can be projected in a planar shape by displacing the diffractive optical element and scanning a light beam widened in a linear shape. The diffractive optical element can be designed to form a light intensity distribution of 2-dimensional laser light on the surface of the coating film 131, for example, a point, a straight line, or a concentric circle.

The infrared camera 102 includes, for example, a plurality of infrared sensors that are 2-dimensionally arranged. For example, a high-sensitivity infrared camera (which is commercially available) using an infrared sensor using cooling type indium-antimony (InSb) or the like as a detection element can be used.

Sequential scanning is performed with the infrared rays (infrared light) projected from the light source 101 so that there is no coating film surface on which inspection is omitted. The infrared camera 102 sequentially captures images along the scanning so that observation omission does not occur.

The thermal image captured by the infrared camera 102 and displayed on the display unit 103 is an image virtualized by superimposing a state (temperature distribution) of infrared rays emitted from an object (for example, a coating film of a building) on which the infrared rays are projected in the shape of the object.

The observation device includes an image processing circuit 105 that extracts a component vibrating at the same cycle as the frequency of a power supply voltage supplied to the light source 101 from the thermal image captured by the infrared camera 102. The image processing circuit 105 extracts a component vibrating at the same cycle as the frequency from the thermal image captured by the infrared camera 102. A clearer thermal image can be obtained by amplifying the extracted component (lock-in amplification).

The above-described image processing circuit 105 includes a central processing unit (CPU) and a main storage device, and the above-described functions can be implemented by the CPU operating in accordance with a program (executing a program) developed in the main storage device. The program is a program used for the CPU to execute the above-described image processing method.

The thermal image obtained in this way is displayed on the display unit 103. By observing the displayed thermal image, deterioration such as swelling and peeling of the coating film on the surface of the coating film 131, exhaustion, or the like can be detected.

According to the above-described embodiment, the surface of the coating film 131 is irradiated with infrared rays by the light source 101. Therefore, even when sunlight cannot be obtained, a problem of coating such as deterioration or exhaustion of the coating film can be found.

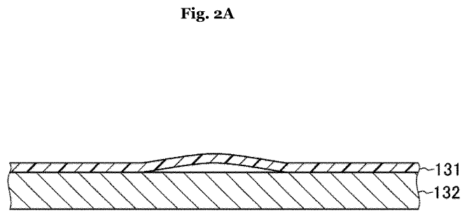

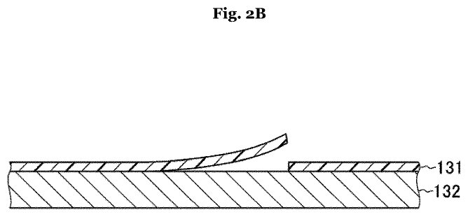

When a portion where the coating film (the coating film 131) has a symptom of swelling (FIG. 2A) or peeling (FIG. 2B) from the base (the steel plate 132) due to corrosion or the like is irradiated with the infrared rays, the radiated portion has a higher temperature than the surrounding that is not irradiated. The intensity of the infrared ray to be radiated (projected) is lower than the intensity of a laser used in a laser processing machine or the like, and weak infrared rays are used to the degree that the infrared rays do not significantly affect the coating film.

On the other hand, an increase in a temperature of a coating film (coating film) portion which is in close contact with a base (steel or the like) is inhibited by thermal conduction even when the coating film portion is irradiated with the infrared rays. Accordingly, there is a difference in temperature between a portion with a symptom such as peeling and a portion with no symptom when the infrared rays are radiated. This temperature difference is shown in the thermal image. For example, in the thermal image, this portion (place) is displayed in red and is distinguished from other portions. By observing this state, it is possible to identify a portion where the coating film swells or peels, and it is possible to identify a portion where corrosion progresses on the base.

Here, the lock-in thermographic technique (an overview of lock-in amplification) will be briefly described. Thermal image analysis performed using infrared rays (infrared thermography) is a technique of detecting the infrared rays emitted from an object with an infrared camera and superimposing and visualizing the infrared rays on the shape of the object as a temperature.

First, in the lock-in, a multiplier output signal that has a direct current of cos(β−α)/2−cos(2ωt+α+β)/2 and a component of a double frequency (2ωt) is obtained by multiplying a measured signal (observation infrared rays) sin(ωt+α) by a reference signal sin(ωt+β) of the frequency of the power supply voltage supplied to the light source 101. Of the multiplier output signals, a thermal image can be obtained by passing only a DC component through a lowpass filter (LPF) that has a high Q factor to remove a noise component, and passing and amplifying only a weak photoelectric conversion signal synchronized with a reference signal (lock-in signal) (Reference Literature 1).

In the narrowband bandpass filter (BPF), a measurement error occurs when a central frequency deviates from a signal frequency, and the signal itself is removed in the worst case. In the lock-in amplification, however, even when a cutoff frequency of the LPF deviates to some extent, there is no influence on an imaging result as long as only a direct current can be passed. It is easier to implement the narrowband LPF than the BPF, and thus a band can be implemented as narrow as possible. Since the lock-in amplification is advantageous for amplification of a weak signal buried in noise, it is possible to detect weak thermal radiation generated from swelling and peeling of a coating film at a remote location above the ground with high sensitivity.

As described above, according to embodiments of the present invention, a thermal image of a place irradiated (projected) with infrared rays from a light source are captured by the infrared camera. Therefore, even when sunlight cannot be obtained, it is possible to find a problem of coating such as deterioration and exhaustion of a coating film.

The present invention is not limited to the above-described embodiment, and it is apparent that various modifications and combinations can be implemented by those skilled in the art without departing from the technical spirit of the present invention.
Reference Literature 1 NF Corporation “Zatsuon ni umoreta shingo no sokutei-rokkuinanpu o mochiita bisho shingo no sokutei rokkuinanpu no genri (in Japanese) (Measurement of signal buried in noise-measurement of minute signal using lock-in amplifier, principle of lock-in amplifier) (1)” manufactured by NF Corporation, [retrieved on Mar. 8, 2022], http://www.nfcorp.co.jp/techinfo/keisoku/noise/li_genri1.html.

### REFERENCE SIGNS LIST

101 Light source
102 Infrared camera
103 Display unit
104 Power supply
105 Image processing circuit
131 Coating film

1-4. (canceled)

5. An observation device comprising:
a light source configured to radiate infrared rays on a surface of a target coating film;
an infrared camera configured to capture a thermal image of a location on the surface of the target coating film that was irradiated with the infrared rays; and
a display configured to display the thermal image captured by the infrared camera.

6. The observation device according to claim 5,
wherein the light source is an infrared projector.

7. The observation device according to claim 5,
wherein the light source includes an infrared laser and a diffractive optical element configured to widen an irradiation distribution of infrared laser light emitted from the infrared laser.

8. The observation device according to claim 5,
wherein a power supply of the light source supplies a power supply voltage of a set frequency to the light source, and
the observation device further comprises an image processing circuit configured to extract a component vibrating at a same cycle as a frequency from a thermal image captured by the infrared camera.

9. The observation device according to claim 5, wherein the light source is configured to radiate infrared rays across an entirety of the surface of target coating film.

10. The observation device according to claim 5, wherein the light source is configured to radiate infrared rays across the entirety of the surface of target coating film by sequentially scanning across the entirety of the surface of the target coating film.

11. The observation device of claim 5, wherein the target coating film is disposed a structure located underground.

12. A method comprising:
radiating, by a light source, infrared rays on a surface of a target coating film;
capturing, by an infrared camera, a thermal image of a location on the surface of the target coating film that was irradiated with the infrared rays;
displaying the thermal image captured by the infrared camera on a display; and
determining whether there is a defect in the target coating film based on the thermal image.

13. The method according to claim 12, wherein the defect in the target coating film is swelling or peeling of the target coating film.

14. The method according to claim 12, wherein determining whether there is the defect in the target coating film based on the thermal image comprises determining there is the defect in the target coating film in response to detecting a temperature difference at the location on the surface of the target coating film.

15. The method according to claim 12,
wherein the light source is an infrared projector.

16. The method according to claim 12,
wherein the light source includes an infrared laser and a diffractive optical element configured to widen an irradiation distribution of infrared laser light emitted from the infrared laser.

17. The method according to claim 12, further comprising radiating infrared rays across an entirety of the surface of target coating film.

18. The method according to claim 17, wherein radiating infrared rays across the entirety of the surface of target coating film comprises sequentially scanning across the entirety of the surface of the target coating film.
